(19) United States
(12) Patent Application Publication
(10) Pub. No.: US 2023/0375266 A1
(43) Pub. Date: Nov. 23, 2023

(54) PROCESS AND APPARATUS FOR THE COOLING OF A CO2-RICH FLOW

(71) Applicant: L'Air Liquide, Societe Anonyme pour l'Etude et l’Exploitation des Procedes Georges Claude, Paris (FR)

(72) Inventors: Martin RAVENTOS, Champigny sur Marne (FR); Richard DUBETTIER-GRENIER, Champigny sur Marne (FR); Mathieu LECLERC, Champigny sur Marne (FR); Thomas MOREL, Champigny sur Marne (FR)

(73) Assignee: L'Air Liquide, Societe Anonyme pour l'Etude et l’Exploitation des Procedes Georges Claude, Paris (FR)

(21) Appl. No.: 18/199,357

(22) Filed: May 18, 2023

(30) Foreign Application Priority Data
May 20, 2022 (FR) FR 2204833

(51) Int. Cl. F25J 3/06

(52) U.S. Cl. CPC F25J 3/067; F25J 3/061; F25J 3/0635

(57) ABSTRACT

In a process for the recovery of cold from a methane-rich fluid for the cooling of a flow rich in carbon dioxide, cold is provided to a first heat exchanger for the cooling of the flow by the evaporation of an intermediate fluid by exchange of heat with the methane-rich fluid in order to form at least one condensed intermediate fluid flow at at least one pressure level; at least a part of the intermediate fluid evaporated in a second heat exchanger is condensed at at least one pressure into at least one flow.

### CROSS REFERENCE TO RELATED APPLICATIONS

This application claims the benefit of priority under 35 U.S.C. § 119 (a) and (b) to French patent application No. FR2204833, filed May 20, 2022, the entire contents of which are incorporated herein by reference.

### FIELD OF THE INVENTION

The present invention relates to a process and to an apparatus for the cooling of a CO₂-rich flow.

### BACKGROUND OF THE INVENTION

The liquefaction of a flow rich in carbon dioxide generally consumes electricity in order to provide the required refrigeration. Liquid natural gas is often evaporated against seawater or another heat provider. The two systems have complementary requirements, because the evaporation of liquefied natural gas requires heat and the liquefaction of carbon dioxide necessitates having a source of cold. It is thus advantageous to investigate the possibility of integrating the two systems.

In principle, since the amount of LNG available as refrigerant is “unlimited”, it should be possible to condense the CO₂ at a fairly low pressure, in order to minimize the liquefaction energy, compared with that required by a liquefaction where the CO₂ is compressed to a supercritical pressure, densified and then reduced in pressure to a stripping column. On the other hand, the choice of a very low liquefaction pressure can limit the CO₂ yield of the liquefaction process since the profile of the temperatures in the stripping column is limited.

The use of a direct exchange of heat between the LNG (typically available at between −160° C. and −145° C.) as refrigerant and the CO₂ cannot be envisaged because of the risk of freezing of CO₂. This means that an intermediate fluid has to be used in order to transport cold from the LNG to the CO₂. This can be carried out in two ways:
a) transporting cold from the LNG solely in the form of sensible heat of the intermediate fluid (in this case, the latter can be gaseous nitrogen, a liquid HFO),
b) transporting cold from the LNG through the sensible heat and the latent heat of the intermediate fluid.

The disadvantage of option a) is the incompatibility between the enthalpy/temperature profiles of the CO₂, which condenses, and the intermediate fluid in the heat exchanger (the majority of the heat is produced by the CO₂ at constant temperature, whereas the temperature of the intermediate fluid increases at a constant rate, according to its flow rate and its specific heat). This obstacle can be avoided, for example, by increasing the flow rate of the intermediate fluid and/or by increasing the pressure of the CO₂ in order to approach the critical pressure, indeed even to exceed it. Both solutions require increasing the energy and thus these solutions are less attractive.

It is known, from FR 2 869 404, JP2004069215 and JPH04148182, to use the cold from a flow of LNG which evaporates in order to cause carbon dioxide to condense, by using a coolant cycle, the coolant being ethane.

JPH04-131688 describes a closed cycle of intermediate fluid which transfers cold from a flow of LNG to a flow of CO₂ to be liquefied, the cycle comprising a pump in order to pressurize the intermediate fluid. The fluid used is Freon®.

FR 2 869 404 describes a closed cycle of intermediate fluid which transfers cold from a flow of LNG to a flow of CO₂ to be liquefied, the intermediate fluid being ethane which evaporates against the CO₂ and liquefies against the LNG. The pressure of the intermediate fluid is constant.

Since the majority of the cold is available at lower temperatures than those of the liquefaction of CO₂, it should be possible, at least from a thermodynamic viewpoint, to integrate the processes with a zero energy cost, indeed even with generation of energy. In a practical context, a form of integration is sought having only a limited energy consumption (for example by using only pumps, without compression not driven by a turbine) and which is compatible with the use of compact multifluid exchangers (for example a plate and fin exchanger made of brazed aluminium). Ideally, the process should make it possible for the LNG to be heated up to ambient temperature, in order to inject it into a natural gas network or to supply it to customers without having to heat it with a separate heating means.

The present invention is targeted at improving the known processes by reducing the risk of freezing the carbon dioxide in the process of cooling, indeed even liquefaction, of carbon dioxide.

It uses an intermediate fluid to recover the cold from the LNG composed mainly of ethane and/or of ethylene, which can also comprise methane. This fluid will be designated as C₂ fluid. This fluid preferably contains at least 90 mol % of ethane or of ethylene.

This intermediate fluid makes it possible, preferably, to recover cold down to temperatures of less than −60° C.

A dedicated heat exchanger (referred to as “LNG exchanger”) is used to exchange heat between the intermediate fluid and the methane-rich liquid, for example liquefied natural gas LNG, in liquid form or in dense phase. The LNG is heated or evaporated (according to its pressure) against the C₂ fluid which condenses and is cooled to a temperature of less than −50° C. in a single pass or in multiple passes in parallel operating at different pressures (Pc1, Pc2, PcN, where N is typically between 2 and 4), in order to limit the differences in temperatures between fluids of the exchanger. The LNG exchanger will be typically a plate and fin exchanger made of brazed aluminium or of stainless steel, a shell-and-tube exchanger or a printed circuit exchanger.

If a multifluid exchanger is used, the flows of C₂ fluid are preferably subcooled down to a temperature between 2-10 K above the inlet temperature of the LNG in the exchanger. At the cold end of the same exchanger, all the subcooled C₂ fluids are mixed at a pressure P1, optionally using at least one pump, and heated in another passage of the same exchanger up to a temperature between 2 and 5K below the bubble point of the flows mixed at the pressure P1. The subcooling of the C₂ fluid in the vicinity of −60° C. is solely a means of limiting the differences in temperatures in the exchanger.

The resulting flow of C₂ fluid at the pressure P1 is subsequently heated and evaporated against the CO₂ which condenses, the CO₂ being ideally at a single pressure between 10-16 bara in another heat exchanger for several fluids, the C₂ fluid traversing this exchanger either at a single pressure, or in parallel at two pressures P1 and P2<P1. If two evaporation pressures are used, P2 should typically correspond to the bubble point of the C₂ fluid at approximately −55° C. In this case, the flow rate of the C₂ fluid evaporated at P1 would be much smaller (for example between 25 and 35 times smaller) than the flow rate of the C₂ fluid evaporated at P2, the latter providing the majority of the refrigeration associated with the condensation of CO₂ and the former providing the majority of refrigeration associated with the subcooling of CO₂ and the production of reflux for the CO₂ distillation column.

The C₂ fluid evaporated at P1 (or the fluids evaporated at P1 and at P2) obtained at the hot end of the heat exchanger where the CO₂ condenses has to be designed to produce the required flow rates at the condensation pressures Pc1, Pc2, PcN chosen for the LNG heating exchanger. It is necessary, starting from two streams available at two different pressures, to form N streams, at pressure values Pc1, Pc2, PcN and with specific flow rates. This assumes compressing at least one stream and/or reducing in pressure at least one stream. It is important to upgrade the pressure of the original streams (that is to say, by minimizing the compression, particularly if it cannot be driven by the reduction in pressure of another stream in a turbine)

Ideally, only one of the condensation pressures Pc1, Pc2, PcN is greater than P1. With this aim, a part of the gaseous C₂ fluid at P1 is compressed by a centrifugal compressor up to the highest of the condensation pressures. The C₂ fluid at the other condensation pressures is obtained by reducing in pressure the remainder of the C₂ fluid in at least one valve JT and a centrifugal turbine. By choosing the appropriate pressures and flow rates, it is possible for the turbine to drive the compressor, so that the only consumption of energy is that of the pump.

The number of flow rates of C₂ fluid at different pressure passing through the LNG heating exchanger is chosen as a function of the composition of the C₂ fluid and of the type of exchanger which are used. In general terms, the greater the number of flows, the smaller the differences in temperature between the fluids, so that the heating can, for example, be carried out in a plate and fin exchanger made of brazed aluminium.

CN105545390A and JP H04 121573A describe a process according to the prior art.

### SUMMARY OF THE INVENTION

An aim of certain embodiments of the present invention is to limit the differences in temperature at the cold end of one of the exchangers, in order to increase the efficiency of the process.

In certain embodiments, at least a part of the cold required for cooling, indeed even liquefaction, is provided by the heating of a methane-rich fluid, for example the evaporation of a methane-rich liquid, for example containing at least 80 mol % of methane, or the pseudo-evaporation of a methane-rich fluid in the dense phase. An example of such a liquid is liquefied natural gas (LNG). The transfer of cold is carried out by using an intermediate fluid rich in ethane or ethylene in order to transfer cold from the liquefied gas, for example from liquefied natural gas, to the liquefaction of the CO₂-rich flow.

The CO₂-rich flow comprises at least 70 mol % of carbon dioxide, preferably at least 90 mol % of carbon dioxide, indeed even at least 95 mol % of carbon dioxide.

According to an embodiment of the invention, there is provided a process for the recovery of cold from a methane-rich fluid, for example liquefied natural gas, for the cooling and optionally the liquefaction, indeed even the separation, of a flow rich in carbon dioxide, in which:
i. the flow rich in carbon dioxide is cooled and optionally condensed, at least partially, in a first heat exchanger at a pressure of greater than 5 bar abs, indeed even of greater than 13 bar abs;
ii. cold is provided for stage i) by the evaporation of an intermediate fluid containing at least 80 mol % of ethane or of ethylene at at least one pressure level, preferably at a single pressure level;
iii. at least a part of the intermediate fluid evaporated in stage ii) is condensed in a second heat exchanger at at least one pressure into at least one flow, preferably at a single pressure into a single flow, by exchange of heat with the methane-rich fluid to form at least one condensed intermediate fluid flow;
iv. the at least one condensed intermediate fluid flow is pressurized by means of a pump, characterized in that:
v. the at least one flow pressurized by the pump is heated in the second heat exchanger up to an intermediate temperature of the exchanger, the intermediate temperature being a temperature greater than that of a cold end of the second heat exchanger and lower than that of the hot end of the second heat exchanger, and is sent to the first heat exchanger in order to be evaporated according to stage ii).

According to other optional aspects of the invention:
the methane-rich fluid is a gas or a liquid,
a part of the intermediate fluid is condensed at a first pressure in the second exchanger and at least another part of the intermediate fluid is condensed at at least a pressure lower than the first pressure in the second exchanger,
the at least another part of the intermediate fluid condensed at the at least a pressure lower than the first pressure is pressurized up to the first pressure in the pump,
the at least a part of the intermediate fluid heated according to stage iv) comprises the part of the intermediate fluid condensed at the first pressure and at least a part of the intermediate fluid pressurized by the pump,
at least one condensation pressure of the intermediate fluid in the second heat exchanger is higher, preferably by at least 2 bars, than the evaporation pressure of the intermediate fluid in the first heat exchanger or, when there are several evaporation pressures of intermediate fluids, than the highest of the evaporation pressures of the intermediate fluid in the first heat exchanger,
the compression of the part of the evaporated intermediate fluid which is condensed at a higher pressure than the evaporation pressure of the intermediate fluid in the first heat exchanger or, when there are several evaporation pressures of intermediate fluids, than the highest of the evaporation pressures is carried out by a compressor driven by a turbine which reduces in pressure another part of the evaporated intermediate fluid,
the intermediate fluid cycle does not comprise a compressor or does not comprise a compressor driven by a motor,
the evaporation pressures of the intermediate fluid in the first heat exchanger are between 3 bara and 25 bara, preferably between 4 bara and 21 bara, and/or the condensation pressures of the intermediate fluid in the second heat exchanger are between 1.05 bara and 50 bara, preferably between 1.3 bara and 45 bara,
the intermediate fluid contains more than 85 vol % of ethane and preferably more than 90 vol % of ethane,
the intermediate fluid contains more than 85 vol % of ethylene and preferably more than 90 vol % of ethylene,
the ratio of the at least one molar flow of intermediate fluid to the molar flow of the flow rich in carbon dioxide which are sent to the first heat exchanger is between 1.0 and 1.5, preferably between 1 and 1.4,
the ratio of the at least one molar flow of intermediate fluid to the molar flow of methane-rich gas, for example LNG, which are sent to the second heat exchanger is between 0.7 and 1.0, preferably 0.75 and 0.95,
the liquefied CO₂-rich gas is produced at a temperature equal to or less than −40° C. and preferably equal to or less than −50° C.,
the flow rich in carbon dioxide at the inlet of the first exchanger contains more than 30 vol % of CO₂, preferably more than 35 vol % of CO₂,
the flow rich in carbon dioxide at the inlet of the first exchanger contains more than 90 vol % of CO₂, preferably more than 95 vol % of CO₂,
at least a part of the methane-rich gas heated or evaporated in the second heat exchanger is sent, as fuel or as reactant, to a steam methane reforming unit, an autothermal reforming unit or a partial oxidation unit and the CO₂-rich flow is produced by this unit or derived from a product from this unit,
a CO₂-rich liquid produced by the liquefaction or the separation by partial condensation or distillation of the flow rich in carbon dioxide is subcooled in the first exchanger by exchange of heat with the at least a part of the intermediate fluid heated in the second heat exchanger up to an intermediate temperature,
a CO₂-rich liquid produced by the liquefaction or the separation by distillation or condensation of the flow rich in carbon dioxide is subcooled in the first exchanger by exchange of heat with the at least a part of the intermediate fluid heated in the second heat exchanger up to the intermediate temperature,
the CO₂-rich flow is separated in at least one distillation column,
a part of a CO₂-rich liquid taken from the bottom of the distillation column is evaporated in the first heat exchanger at a temperature greater than the intermediate temperature and returned to the bottom of the distillation column,
a part of the intermediate fluid heated in the first exchanger is reduced in pressure in a turbine in order to generate electricity.

According to another subject-matter of the invention, there is provided an apparatus for the recovery of cold from a methane-rich fluid, for example liquefied natural gas, for the cooling and optionally the liquefaction, indeed even the separation, of a flow rich in carbon dioxide comprising a first heat exchanger, a second heat exchanger, means for sending, to be cooled and optionally to be condensed, at least partially, the flow rich in carbon dioxide into a first heat exchanger, a closed intermediate fluid cycle comprising means for sending the intermediate fluid, containing at least 80 mol % of ethane or of ethylene, to be evaporated in the first exchanger at at least one pressure level, preferably at a single pressure level, means for sending the evaporated fluid to be condensed in the second heat exchanger at at least one pressure into at least one flow, preferably at a single pressure into a single flow, by exchange of heat with the methane-rich fluid, to form at least one condensed intermediate fluid flow, a pump for pressurizing the at least one condensed intermediate fluid flow, characterized in that it comprises means for sending the flow from the pump to the second heat exchanger in order to be heated up to an intermediate temperature of the exchanger, the intermediate temperature being a temperature greater than that of a cold end of the second heat exchanger and lower than that of the hot end of the second heat exchanger, and means for extracting the heated flow from the second heat exchanger at the intermediate temperature being connected to the means for sending the intermediate fluid containing at least 80 mol % of ethane or of ethylene to be evaporated into the first exchanger.

### BRIEF DESCRIPTION OF THE DRAWINGS

Further features and advantages of the invention will become apparent from the description hereinafter of embodiments, which are given by way of illustration but without any limitation, the description being given in relation with the following attached FIGS.

FIG. 1 represents a process for the condensation of CO₂ by exchange of heat with a methane-rich liquid, for example LNG, using a cycle, the fluid of which is 100% ethane.

FIG. 2 represents a process for the condensation of CO₂ by exchange of heat with a methane-rich liquid, for example LNG, using a cycle, the fluid of which is 100% ethylene.

FIG. 3 represents a process for the condensation of CO₂ by exchange of heat with a methane-rich liquid, for example LNG, using a cycle, the fluid of which is 93.5 mol % ethane and 6.5 mol % methane.

FIG. 4 represents a process for the condensation of CO₂ by exchange of heat with a methane-rich liquid, for example LNG, using a cycle, the fluid of which is ethylene with from 6% to 7% of methane.

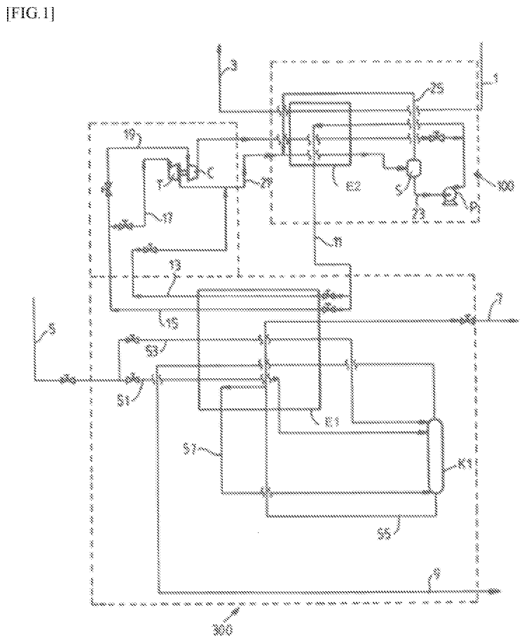

### DETAILED DESCRIPTION OF THE INVENTION

[FIG. 1] represents a process for the condensation of CO₂ by exchange of heat with a methane-rich liquid, for example LNG, using a cycle, the fluid of which is 100% ethane, with two flow rates of fluids condensing in the exchanger at two different condensation pressures. A flow of liquefied natural gas (LNG) 1 is sent to the cold end of a heat exchanger E2 which can be a plate and fin exchanger or a printed circuit exchanger. The liquefied natural gas is evaporated and heated in the exchanger E2 to produce natural gas 3 exiting from the hot end, preferably at a temperature above 0° C., for example ambient temperature. The fluid 1 can be a gas or a liquid.

In the heat exchanger E2, two C₂ flows, in this instance ethane, 19, 21, are cooled, the flow 21 being at a lower pressure than the flow 19. The flow 21 passes through the heat exchanger E1 from the hot end to the cold end while being completely condensed. The condensed flow is sent into a drum S. The liquid 23 from the drum S is pressurized by a pump P and mixed with the flow 19 which has condensed and which is reduced in pressure in a valve. The flow 11 formed is desubcooled, thus heated, in the heat exchanger E1 up to an intermediate temperature of the exchanger, that is to say a temperature between that of the cold end and of the hot end of the exchanger.

The flow 11 is sent to the CO₂ liquefier, either in a thermally insulated pipe or by passing through a thermally insulated cold box common to the exchanger E2 and to the CO₂ liquefier. The flow 11 is divided into two and the two parts 13, 15 are reduced in pressure in respective valves and heated in a heat exchanger E1 on passing from the cold end to the hot end. After heating, the flow 15 is divided into two in order to form the flows 19, 17. The flow 19 is compressed in a compressor C, cooled in a cooler (not illustrated) and sent at the outlet pressure of the latter to the exchanger E2. The flow 17 is reduced in pressure from the pressure P1 in a turbine T which drives the compressor C and is mixed with the flow 13 to form the flow 21 which enters the exchanger E2.

The flow 5 rich in carbon dioxide at between 10-16 bara is divided into two parts 51, 53. The flow 53 passes completely through the exchanger E1 and is sent as top reflux of a distillation column K1, being condensed in the exchanger E1. The other part 51 is cooled in the exchanger E1 at the same pressure as the part 53 but exits from the exchanger E1 at a temperature intermediate between those of the hot end and of the cold end. The part 51 is subsequently sent to the column K1.

The reboiling of the column K1 is provided by taking a part 57 of the bottom liquid 55 from the column K1 enriched in carbon dioxide. The bottom liquid 55 is sent to an intermediate level of the exchanger E1 which is hotter than the outlet point of the flow 51. The part 57 is evaporated and heated and returned to the bottom of the column K1 as gas. The remainder 7 of the liquid 55 is subcooled in the heat exchanger E1 by exchange of heat with the intermediate fluid 11 and forms the liquid carbon dioxide which is the product of the process. The top gas 9 from the column K1 is heated in the exchanger E1 from the cold end up to the hot end and exits from the system. This gas 9 is enriched in light impurities, such as nitrogen, hydrogen, carbon monoxide, and the like.

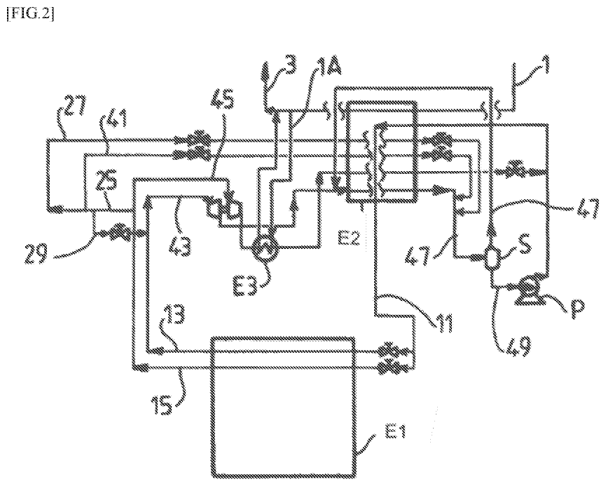

The condensation pressure of the flow 19 of intermediate fluid in the second heat exchanger E2 is higher, preferably by at least 2 bars, than the highest of the evaporation pressures of the intermediate fluid in the first heat exchanger E1.

[FIG. 2] represents a process for the condensation of CO₂ by exchange of heat with a methane-rich liquid, for example LNG, using a cycle, the C₂ fluid of which is 100% ethylene. The particulars of the CO₂ liquefier are not given but a process identical to or similar to that of [FIG. 1] can be used for the liquefaction.

In this instance, the C₂ fluid is evaporated at two different pressures in the exchanger E2 in order to condense the gas rich in carbon dioxide. The gas 15 taken at the hot end of the exchanger E1 is divided into two. A part 45 is compressed in the compressor, cooled in a heat exchanger E3 and subsequently condensed in the heat exchanger E2 against LNG. The remainder 25 of the gas 15 is divided into three, one part 29 being mixed with the gas 13 to form a gas 43 which is reduced in pressure in the turbine driving the compressor and subsequently is sent to the exchanger E2 in order to be completely condensed, forming the liquid flow 47 sent to the drum S.

Another part 27 of the gas 25 is reduced in pressure, then sent to the heat exchanger E2, where it is condensed and subcooled, then mixed with the subcooled liquid 47.

Another part 41 of the gas 25 is reduced in pressure, then sent to the heat exchanger E2, where it is condensed and subcooled, then mixed with the liquid 47.

Thus, it is seen that the fluid C₂, in this instance ethylene, is condensed at four different pressures in the exchanger E2.

The exchanger E2 can be a plate and fin exchanger, for example made of brazed aluminium, since there is a cooler downstream of the compression of the flow 45. The turbine is fed with the flow of C₂ fluid, in this instance ethylene, at the pressure P2.

The exchanger E3 is cooled by means of a flow 1A of evaporated LNG taken at the hot outlet of the exchanger E2.

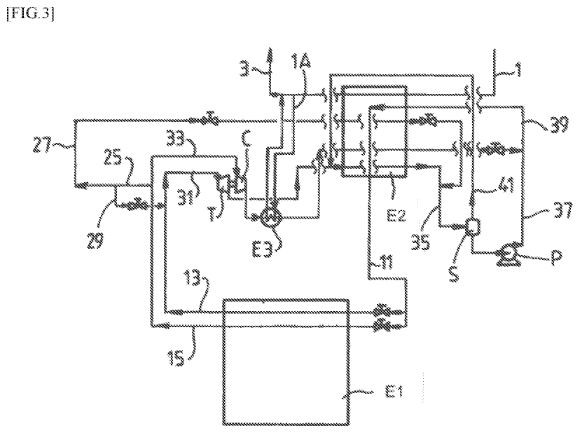

The condensation pressure of the flow 45 of intermediate fluid in the second heat exchanger is higher, preferably by at least 2 bars, than the highest of the evaporation pressures of the intermediate fluid in the first heat exchanger.

[FIG. 3] represents a process for the condensation of CO₂ by exchange of heat with LNG using a cycle, the C₂ fluid of which is 93.5 mol % ethane and 6.5 mol % methane. The particulars of the CO₂ liquefier are not given but a process identical to or similar to that of [FIG. 1] can be used for the liquefaction.

In this instance, the C₂ fluid is evaporated at two different pressures in the exchanger E1 in order to condense the gas rich in carbon dioxide. The gas 15 taken at the hot end of the exchanger E1 is divided into two. A part 33 is compressed in the compressor C, cooled in a heat exchanger E3 and subsequently condensed in the heat exchanger E2 against LNG. The remainder 25 of the gas 15 is divided into two, one part 29 being mixed with the gas 13 to form a gas 43 which is reduced in pressure in the turbine T driving the compressor C and subsequently is sent to the exchanger E2 in order to be completely condensed, forming the liquid flow 35 sent to the drum S.

The other part 27 of the gas 25 is reduced in pressure in a valve, then sent to the heat exchanger E2, where it is condensed, then it is mixed with the subcooled flow 35 upstream of the drum S.

The exchanger E3 is cooled by means of a flow 1A of evaporated LNG taken at the hot outlet of the exchanger E2.

The exchanger E2 can be a plate and fin exchanger, for example made of brazed aluminium, since there is a cooler E3 downstream of the compression of the flow 33. The turbine is fed with the flow of C₂ fluid at the pressure P2.

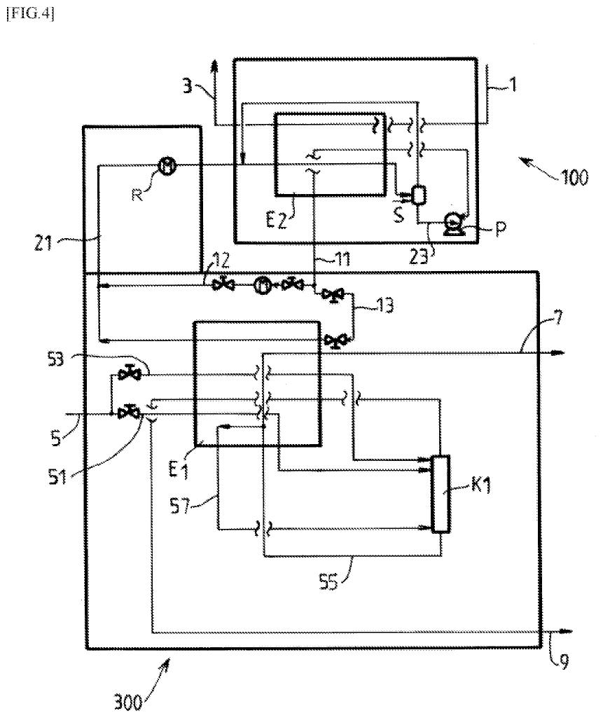

The condensation pressure of the flow 33 of intermediate fluid in the second heat exchanger is higher, preferably by at least 2 bars, than the highest of the evaporation pressures of the intermediate fluid in the first heat exchanger.

[FIG. 4] represents a process for the condensation of CO₂ by exchange of heat with a methane-rich liquid, for example LNG, using a cycle, the fluid of which is 93 mol % ethylene and 7 mol % methane, with a single flow of fluid condensing in the exchanger E2. A flow of liquefied natural gas (LNG) 1 is sent to the cold end of a heat exchanger E2 which can be a plate and fin exchanger or a printed circuit exchanger. The liquefied natural gas is evaporated and heated in the exchanger E2 to produce natural gas 3 exiting from the hot end, preferably at a temperature above 0° C., for example ambient temperature.

A C₂ flow 21 is cooled in the heat exchanger E2. The flow 21 passes through the heat exchanger E1 from the hot end to the cold end while being completely condensed and while being subcooled. The subcooled flow is separated in a drum S. The gas 25 from the drum S rejoins the flow 21 at the inlet of the exchanger E2. The liquid 23 from the drum is pressurized by a pump P. The pumped flow 11 is desubcooled, thus heated, in the heat exchanger E2 up to an intermediate temperature of the exchanger.

The flow 11 is sent to the CO₂ liquefier, either in an insulated pipe or by passing through an insulated cold box common to the exchanger E2 and to the CO₂ liquefier. The flow 11 becomes the flow 13 and is heated in a heat exchanger E1 while passing from the cold end to the hot end. After heating, the flow 13 is heated again, for example up to 60° C., and sent at the outlet pressure of the heater R to the exchanger E2. The flow enters the exchanger E2.

For the start, a flow 12 short-circuits the exchanger E1 in order to make it possible for the intermediate fluid to be heated by a heater.

The flow 5 rich in carbon dioxide at between 10-16 bara is divided into two parts 51, 53. The flow 53 passes completely through the exchanger E1 and is sent as top reflux of a distillation column K1, being condensed in the exchanger E1. The other part 51 is cooled in the exchanger E1 at the same pressure as the part 53 but exits from the exchanger E1 at a temperature intermediate between those of the hot end and of the cold end. The part 51 is subsequently sent to the column K1.

The reboiling of the column K1 is provided by taking a part 57 of the bottom liquid 55 from the column K1 enriched in carbon dioxide. The bottom liquid 55 is sent to an intermediate level of the exchanger E1 which is hotter than the outlet point of the flow 51. The part 57 is evaporated and heated and returned to the bottom of the column K1 as gas. The remainder 7 of the liquid 55 is subcooled in the heat exchanger E1 by exchange of heat with the intermediate fluid 11 and forms the liquid carbon dioxide which is the product of the process. The top gas 9 from the column K1 is heated in the exchanger E1 from the cold end up to the hot end and exits from the system. This gas 9 is enriched in light impurities, such as nitrogen, hydrogen, carbon monoxide, and the like.

The condensation pressure of the flow 19 of intermediate fluid in the second heat exchanger differs from the highest of the evaporation pressures of the intermediate fluid in the first heat exchanger only by the head losses. The intermediate fluid cycle comprises neither compression (apart from the pressurization of the pump) nor reduction in pressure in a turbine. The pump P is used only to compensate for the pressure drop.

[FIG. 1], [FIG. 2], [FIG. 3] and [FIG. 4] respectively can comprise a pipe for conveying gas produced in the drum S upstream of the exchanger E2. This gas results from entries of heat into the drum, which evaporate a small part of the liquid which it contains. The gas formed 25 is sent from the drum S and rejoins the gas 21.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1. A process for the recovery of cold from a methane-rich fluid, for example liquefied natural gas, for the cooling and optionally the liquefaction, indeed even the separation, of a flow rich in carbon dioxide, in which:
a. the flow rich in carbon dioxide is cooled and optionally condensed, at least partially, in a first heat exchanger at a pressure of greater than 5 bar abs, indeed even of greater than 13 bar abs;
b. cold is provided for stage i) by the evaporation of an intermediate fluid containing at least 80 mol % of ethane or of ethylene at at least one pressure level, preferably at a single pressure level;
c. at least a part of the intermediate fluid evaporated in stage ii) is condensed in a second heat exchanger at at least one pressure into at least one flow, preferably at a single pressure into a single flow, by exchange of heat with the methane-rich fluid to form at least one condensed intermediate fluid flow;
d. the at least one condensed intermediate fluid flow is pressurized by means of a pump,
e. heating the at least one flow pressurized by the pump in the second heat exchanger up to an intermediate temperature of the exchanger, the intermediate temperature being a temperature greater than that of a cold end of the second heat exchanger and lower than that of the hot end of the second heat exchanger, and then sending the at least one flow to the first heat exchanger in order to be evaporated according to stage ii).

2. The process according to claim 1, in which a part of the intermediate fluid is condensed at a first pressure in the second exchanger and at least another part of the intermediate fluid is condensed at at least a pressure lower than the first pressure in the second exchanger.

3. The process according to claim 2, in which the at least another part of the intermediate fluid condensed at the at least a pressure lower than the first pressure is pressurized up to the first pressure in the pump.

4. The process according to claim 3, in which the at least a part of the intermediate fluid heated according to stage iv) comprises the part of the intermediate fluid condensed at the first pressure and at least a part of the intermediate fluid pressurized by the pump.

5. The process according to claim 1, in which at least one condensation pressure of the intermediate fluid in the second heat exchanger is higher, preferably by at least 2 bars, than the evaporation pressure of the intermediate fluid in the first heat exchanger or, when there are several evaporation pressures of intermediate fluids, than the highest of the evaporation pressures of the intermediate fluid in the first heat exchanger.

6. The process according to claim 5, in which the compression of the part of the evaporated intermediate fluid which is condensed at a higher pressure than the evaporation pressure of the intermediate fluid in the first heat exchanger or, when there are several evaporation pressures of intermediate fluids, than the highest of the evaporation pressures is carried out by a compressor driven by a turbine which reduces in pressure another part of the evaporated intermediate fluid.

7. The process according to claim 1, in which the intermediate fluid cycle does not comprise a compressor or does not comprise a compressor driven by a motor.

8. The process according to claim 1, in which the evaporation pressures of the intermediate fluid in the first heat exchanger are between 3 bara and 25 bara, preferably between 4 bara and 21 bara, and/or the condensation pressures of the intermediate fluid in the second heat exchanger are between 1.05 bara and 50 bara, preferably between 1.3 bara and 45 bara.

9. The process according to claim 1, in which the intermediate fluid contains more than 85 vol % of ethane and preferably more than 90 vol % of ethane.

10. The process according to claim 1, in which the intermediate fluid contains more than 85 vol % of ethylene and preferably more than 90 vol % of ethylene.

11. The process according to claim 1, in which the ratio of the at least one molar flow of intermediate fluid to the molar flow of the flow rich in carbon dioxide which are sent to the first heat exchanger is between 1.0 and 1.5, preferably between 1 and 1.4.

12. The process according to claim 1, in which the ratio of the at least one molar flow of intermediate fluid to the molar flow of methane-rich gas, for example LNG, which are sent to the second heat exchanger is between 0.7 and 1.0, preferably 0.75 and 0.95.

13. The process according to claim 1, in which the liquefied CO₂-rich gas is produced at a temperature equal to or less than −40° C. and preferably equal to or less than −50° C.

14. The process according to claim 1, in which the flow rich in carbon dioxide at the inlet of the first exchanger contains more than 30 vol % of CO₂, preferably more than 35 vol % of CO₂.

15. The process according to claim 14, in which the flow rich in carbon dioxide at the inlet of the first exchanger contains more than 90 vol % of CO₂, preferably more than 95 vol % of CO₂.

16. The process according to claim 1, in which at least a part of the methane-rich gas heated or evaporated in the second heat exchanger is sent, as fuel or as reactant, to a steam methane reforming unit, an autothermal reforming unit or a partial oxidation unit and the CO₂-rich flow is produced by this unit or derived from a product from this unit.

17. The process according to claim 1, in which a CO₂-rich liquid produced by the liquefaction or the separation by partial condensation or distillation of the flow rich in carbon dioxide is subcooled in the first exchanger by exchange of heat with the at least a part of the intermediate fluid heated in the second heat exchanger up to the intermediate temperature.

18. The process according to claim 1, in which the CO₂-rich flow is separated in at least one distillation column.

19. The process according to claim 18, in which a part of a CO₂-rich liquid taken from the bottom of the distillation column is evaporated in the first heat exchanger at a temperature greater than the intermediate temperature and returned to the bottom of the distillation column.

20. The process according to claim 1, in which a part of the intermediate fluid heated in the first exchanger is reduced in pressure in a turbine in order to generate electricity.

21. An apparatus for the recovery of cold from a methane-rich fluid, for example liquefied natural gas, for the cooling and optionally the liquefaction, indeed even the separation, of a flow rich in carbon dioxide, the apparatus comprising:
a first heat exchanger;
a second heat exchanger;
means for sending, to be cooled and optionally to be condensed, at least partially, the flow rich in carbon dioxide into a first heat exchanger;
a closed intermediate fluid cycle comprising means for sending the intermediate fluid, containing at least 80 mol % of ethane or of ethylene, to be evaporated in the first exchanger at at least one pressure level, preferably at a single pressure level, means for sending the evaporated fluid to be condensed in the second heat exchanger at at least one pressure into at least one flow, preferably at a single pressure into a single flow, by exchange of heat with the methane-rich fluid, to form at least one condensed intermediate fluid flow;
a pump for pressurizing the at least one condensed intermediate fluid flow;
means for sending the flow from the pump to the second heat exchanger in order to be heated up to an intermediate temperature of the exchanger, the intermediate temperature being a temperature greater than that of a cold end of the second heat exchanger and lower than that of the hot end of the second heat exchanger; and
means for extracting the heated flow from the second heat exchanger at the intermediate temperature being connected to the means for sending the intermediate fluid containing at least 80 mol % of ethane or of ethylene to be evaporated into the first exchanger.
